(19) United States
(12) Patent Application Publication
(10) Pub. No.: US 2026/0106284 A1
(43) Pub. Date: Apr. 16, 2026

(54) BATTERY MODULE

(71) Applicant: TOYOTA JIDOSHA KABUSHIKI KAISHA, Aichi-ken (JP)

(72) Inventor: Takeru HARA, Toyota-shi (JP)

(21) Appl. No.: 19/322,685

(22) Filed: Sep. 9, 2025

(30) Foreign Application Priority Data
Oct. 11, 2024 (JP) 2024-179295

(51) Int. Cl. H01M 50/186

(52) U.S. Cl. CPC H01M 50/186

(57) ABSTRACT

A battery module includes: an outer casing configured to accommodate a power storage module stack, the outer casing including a current collector configured to conduct electricity from the power storage module stack, and a laminate seal portion configured to join the outer casing to an outer casing of another battery module. The current collector and the laminate seal portion are joined with a sealing material, and the sealing material is discontinuously disposed at a peripheral edge of the current collector.

The present application claims priority to and incorporates by reference the entire contents of Japanese Patent Application No. 2024-179295 filed in Japan on Oct. 11, 2024.

### BACKGROUND

### 1. Technical Field

The present disclosure relates to a battery module.

### 2. Related Art

JP 2024-42569 A discloses an outer casing of a battery module including a current collector (metal sheet) and a laminate sheet portion surrounding the current collector.

### SUMMARY

In the battery module disclosed in JP 2024-42569 A, the current collector and the laminate seal portion are joined with a long sealing material. However, when the current collector and the laminate seal portion are joined with such a long sealing material using, for example, a long heater, the stress on the current collector increases due to the shrinkage of the sealing material, and there is a possibility that wrinkles occur in the current collector. This may lead to poor quality (e.g., incorrect height dimension) of the battery module.

It is desirable to provide a battery module capable of suppressing occurrence of wrinkles in a current collector.

In some embodiments, a battery module includes an outer casing configured to accommodate a power storage module stack, the outer casing including a current collector configured to conduct electricity from the power storage module stack, and a laminate seal portion configured to join the outer casing to an outer casing of another battery module. The current collector and the laminate seal portion are joined with a sealing material, and the sealing material is discontinuously disposed at a peripheral edge of the current collector.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a cross-sectional view illustrating a configuration of a peripheral portion of a battery module according to an embodiment;

FIG. 2 is a view for explaining a first aspect of the sealing material in the battery module according to the embodiment, and is a plan view illustrating a state in which the current collector and the sealing material are viewed from above;

FIGS. 3A to 3C are views for explaining a second aspect of the sealing material in the battery module according to the embodiment, and are plan views illustrating a state in which a peripheral edge of the current collector and a sealing material disposed in the peripheral edge are viewed from above; and

FIGS. 4A to 4C are diagrams for explaining a third aspect of the sealing material in the battery module according to the embodiment, and are side views illustrating a state in which a peripheral edge of the current collector and a sealing material disposed in the peripheral edge are viewed from the side.

### DETAILED DESCRIPTION

A battery module according to an embodiment of the present disclosure will be described with reference to the drawings. Incidentally, the constituent elements in the following embodiments include those that can be easily replaced by a person skilled in the art or those that are substantially the same.

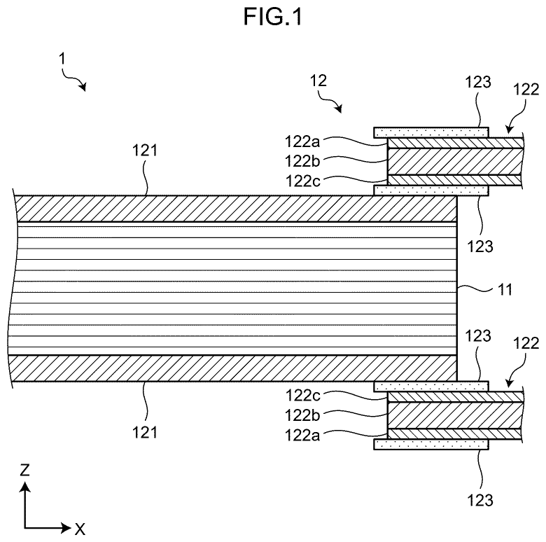

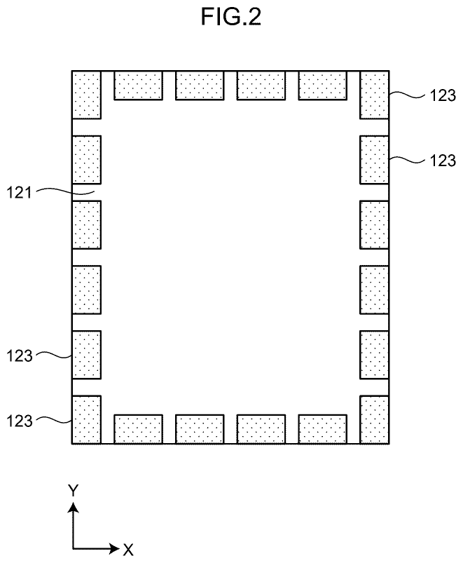

A configuration of a battery module according to the embodiment will be described with reference to FIGS. 1 and 2. The battery module according to the embodiment is used as a battery of, for example, a Hybrid Electric Vehicle (HEV), a Plug-in Hybrid Electric Vehicle (PHEV), a Battery Electric Vehicle (BEV), or the like.

FIG. 1 is a cross-sectional view illustrating a configuration of a peripheral portion of a battery module 1. As illustrated in FIG. 1, the battery module 1 includes a power storage module stack 11 and an outer casing 12. The battery module 1 is a laminate-type battery module in which the power storage module stack 11 is wrapped with an outer casing 12.

The power storage module stack 11 includes, for example, a plurality of electrodes and a plurality of electrolyte layers, and each electrode and each electrolyte layer are alternately stacked. The power storage module stack 11 is, for example, a non-aqueous secondary battery, an all-solid-state secondary battery, or the like. In the following description, it is assumed that the power storage module stack 11 is a bipolar type nonaqueous lithium ion secondary battery.

The outer casing 12 is configured to accommodate the power storage module stack 11. The outer casing 12 includes a current collector 121, a laminate seal portion 122, and a sealing material 123. Although only a part of the outer casing 12 is illustrated in FIG. 1, the outer casing 12 actually seals the power storage module stack 11. The current collector 121 is configured to conduct electricity from the electricity storage module stack 11.

The current collector 121 is a sheet electrically conductive member, and is made of a metal foil such as aluminum, stainless steel, iron, copper, titanium, or nickel.

The laminate seal portion 122 is configured to join the outer casings 12 to each other. Although not illustrated in FIG. 1, above and below the battery module 1, another battery module 1 is disposed, and the outer casings 12 are joined to each other with the sealing material 123. Further, in FIG. 1, although the illustration of the outer side (right side of FIG. 1) of the upper and lower laminate seal portions 122 of the power storage module stack 11 is omitted, the outer end portions of the upper and lower laminate seal portions 122 are joined to another battery module 1.

The laminate seal portion 122 is formed in a rectangular frame shape in plan view in the same manner as in FIG. 2, and is joined to the peripheral edge portion of the current collector 121 by the sealing material 123. Specifically, the laminate seal portion 122 has a three-layer configuration including a first resin layer 122a, a metallic layer 122b, and a second resin layer 122c.

The first resin layer 122a functions as a sealant layer and a protective layer. As the first resin layer 122a, for example, a polyolefin such as polyethylene (PE) or polypropylene (PP), a polyester such as polyethylene terephthalate (PET), a polyamide such as polystyrene, polyvinyl chloride, or nylon, or the like can be used.

The metallic layer 122b functions as a gas barrier layer. As the metallic layer 122b, for example, aluminum, iron, stainless steel, or the like can be used.

The second resin layer 122c functions as a sealant layer. As the second resin layer 122c, for example, a polyolefin such as polyethylene (PE) or polypropylene (PP), a polyester such as polyethylene terephthalate (PET), a polyamide such as polystyrene, polyvinyl chloride, or nylon, or the like can be used.

The sealing material 123 is configured to join (fuse) the current collector 121 and the laminate seal portion 122. The material of the sealing material 123 is not particularly limited, and may be selected from materials that can be chemically bonded to the metal constituting the current collector 121, for example. Further, as illustrated in FIG. 2, the sealing material 123 is discontinuously disposed at the peripheral edge of the current collector 121.

FIG. 2 is a plan view of the current collector 121 and the sealing material 123 in the battery module 1 when viewed from above. The sealing material 123 illustrated in FIG. 2 shows a state before the laminate seal portion 122 is joined to the current collector 121 with the sealing material 123 fused, for example. A plurality of piece-shaped sealing materials 123 are arranged at the peripheral edge of the current collector 121. The plurality of sealing materials 123 are disposed with a predetermined gap therebetween in the X direction and the Y direction.

Here, in a conventional battery module, a long sealing material is continuously arranged at a peripheral edge of a current collector. That is, the conventional sealing material is formed in a rectangular frame shape in plan view, similarly to the laminate seal portion 122. Further, in the conventional battery module, since the current collector and a laminate seal portion are joined with such a rectangular frame-shaped long sealing material using a long heater, the stress on the current collector due to the shrinkage of the sealing material increases, and wrinkles occur in the current collector.

Therefore, in the battery module 1 according to the embodiment, as illustrated in FIG. 2, the plurality of sealing material divided are arranged in the peripheral edge of the current collector 121. As a result, it is possible to suppress the occurrence of stress in the longitudinal direction (X direction; Y direction) at once. That is, since the stress concentration of the sealing material 123 on the current collector 121 can be dispersed and relaxed, the occurrence of wrinkles in the current collector 121 can be suppressed.

Note that the laminate seal portion 122 is joined to the current collector 121 illustrated in FIG. 2 with the sealing material 123. Here, the resin constituting the sealing material 123 stretches when joined. Therefore, the gap between the sealing materials 123 is filled by the stretch of the resin, and the gap is reduced (or the gap itself is eliminated). As described above, the sealing material 123 may be disposed discontinuously (with a gap therebetween) on the peripheral edge of the current collector 121 at least before the lamination seal portion 122 is joined, and may be disposed continuously (without a gap) after the lamination seal portion 122 is joined.

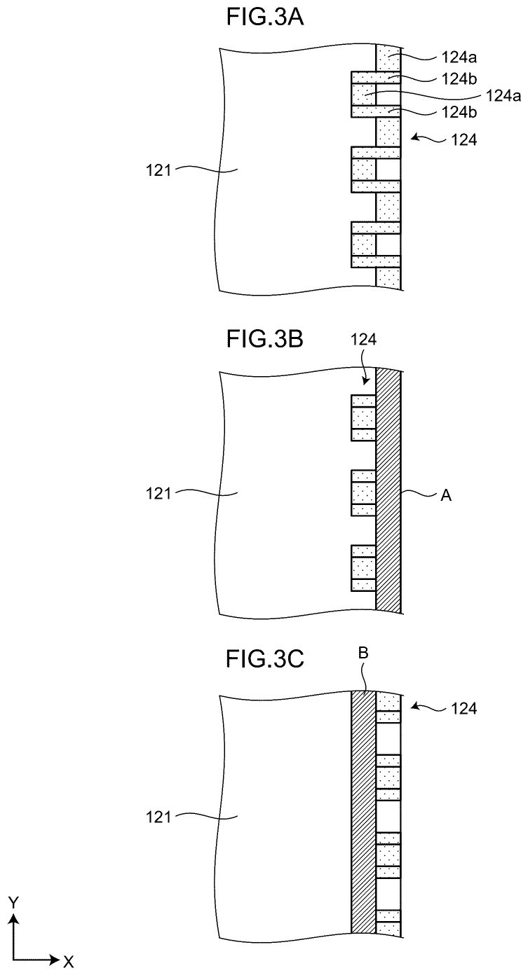

Here, the method of disposing the sealing material discontinuously in the peripheral edge of the current collector is not limited to the embodiment of FIG. 2. For example, as illustrated in FIG. 3A, the sealing material 124 may be arranged in a zigzag manner at a peripheral edge of the current collector 121.

The sealing material 124 includes a first sealing portion 124a extending in the X direction and a second sealing portion 124b extending in the Y direction. In the X direction, only one of the first sealing portion 124a and the second sealing portion 124b is disposed. That is, the first sealing portion 124a and the second sealing portion 124b are not disposed adjacent to each other in the X direction.

In the Y direction, the first sealing portion 124a and the second sealing portion 124b are alternately arranged. That is, the first sealing portion 124a and the second sealing portion 124b are disposed adjacent to each other in the Y direction. As described above, the sealing materials 124 are disposed discontinuously in a particular direction (here, the Y direction) of the peripheral edge of the current collector 121, and a gap exists between the second sealing portions 124b that are disposed adjacent to each other.

When the current collector 121 and the laminate seal portion 122 are joined by the sealing material 124, joining is performed twice. In the first joining, as illustrated in part A of FIG. 3B, for example, the current collector 121 and the laminate seal portion 122 are joined at the outermost position of the peripheral edge of the current collector 121. Further, in the second joining, for example, as illustrated in the portion B of FIG. 3C, the current collector 121 and the laminate seal portion 122 are joined at a position inside the portion A. Note that the joining of FIG. 3C may be performed at the first time, and the joining of FIG. 3B may be performed at the second time.

As described above, by disposing the sealing material 124 in a zigzag manner on the peripheral edge of the current collector 121 and joining the current collector 121 and the laminate seal portion 122, it is possible to disperse and alleviate the stress concentration on the current collector 121 caused by the sealing material 124. Further, the adhesion between the current collector 121 and the laminate seal portion 122 can be further improved.

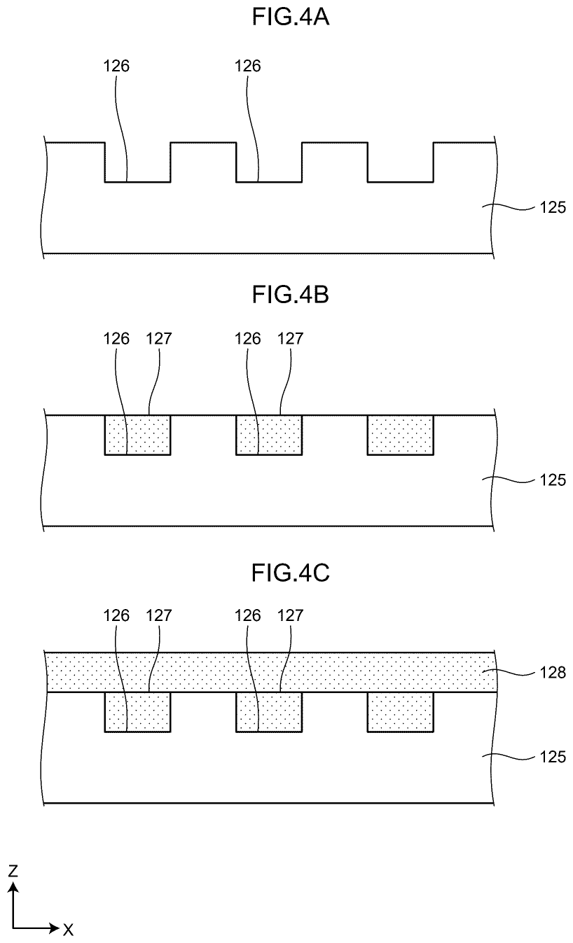

The method of disposing the sealing material discontinuously at the peripheral edge of the current collector is not limited to the embodiments of FIGS. 2 and 3. For example, as illustrated in FIG. 4, the sealing materials 127 may be discontinuously disposed by performing predetermined processing on the current collector 125. As illustrated in FIG. 4, the sealing materials 127 are discontinuously disposed in a specific direction (here, the X direction) when viewed from the side, and a gap exists between adjacent sealing materials 127.

A plurality of recesses 126 are formed on the upper surface of the peripheral edge of the current collector 125. When the current collector 125 and the laminate seal portion 122 are joined to each other, first, as illustrated in FIG. 4B, the recesses 126 are filled with the sealing materials 127. Subsequently, as illustrated in FIG. 4C, the sealing material 128 is disposed on a portion of the peripheral edge of the current collector 125 other than the recesses 126 and on the sealing materials 127, and the laminate seal portion 122 is disposed thereon and joined. Note that the sealing material 128 is formed in a rectangular frame shape in plan view, similarly to the laminate seal portion 122.

By forming the plurality of recesses 126 on the surface of the current collector 125, disposing the sealing materials 127 in the recesses 126 and disposing the sealing material 128 further from above, the laminated sealing portion 122 is joined, it is possible to localize the stress due to the difference in the coefficient of linear expansion. As a result, the stress concentration on the current collector 125 by the sealing materials 127 and 128 can be dispersed and relaxed. Further, the adhesion between the current collector 125 and the laminate seal portion 122 can be further improved.

According to the present disclosure, it is possible to disperse and relax the stress concentration on the current collector by the sealing material, and thus it is possible to suppress the occurrence of wrinkles in the current collector.

Further advantages and variations can be readily derived by one of ordinary skill in the art. Thus, the broader aspects of the invention are not limited to the specific details and representative embodiments presented and described above. Accordingly, various modifications may be made without departing from the spirit or scope of the general inventive concept as defined by the appended claims and their equivalents.

What is claimed is:

1. A battery module comprising:
an outer casing configured to accommodate a power storage module stack, the outer casing including
a current collector configured to conduct electricity from the power storage module stack, and
a laminate seal portion configured to join the outer casing to an outer casing of another battery module,
wherein the current collector and the laminate seal portion are joined with a sealing material, and the sealing material is discontinuously disposed at a peripheral edge of the current collector.
